(19) United States
(12) Patent Application Publication
(10) Pub. No.: US 2010/0005596 A1
(43) Pub. Date: Jan. 14, 2010

(54) Whitening Granular Laundry Detergent

(76) Inventors: Annette Kay Bryan, Cincinnati, OH (US); Julie Ann Cassedy, Hebron, KY (US); Eva Schnelderman, Mason, OH (US); Linda Carol McWilliams, Cincinnati, OH (US); Les Charles Zorb, Loveland, OH (US); Manasvini Egan, Whitley Bay (GB); Jodi Elizabeth Koehler, Cincinnati, OH (US); Donna Jean Maag, Cincinnati, OH (US); Paul R. Mort, III, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/500,676

(22) Filed: Jul. 10, 2009

Related U.S. Application Data
(60) Provisional application No. 61/079,957, filed on Jul. 11, 2008.

(51) Int. Cl. C11D 3/395; C11D 1/12; D06F 39/00

(52) U.S. Cl. 8/159; 510/309; 510/312; 510/307

(57) ABSTRACT

A detergent granule comprising at least one composite material, wherein said at least one composite material comprises: a C10-C13 sodium linear alkylaryl sulfonate and/or an alpha-sulfonated fatty acid ester such as methyl ester sulfonate; an alkaline agent, from about 0.05% to about 1.2%, by weight of said granular detergent admix, of an brightener; and from about 10% to about 35%, by weight of said granular detergent admix, of a bleaching system comprising: a source of peroxide; and a bleach activator.

### CROSS REFERENCE TO COPENDING APPLICATIONS

The present application claims priority to copending U.S. Ser. No. 61/079,957 to Bryan et al, filed Jul. 11, 2008, Applicant docket Number 11107P, the disclosure of which is hereby incorporated by reference.

### FIELD OF THE INVENTION

This invention relates generally to the field of granular laundry detergents. More specifically, this invention relates to an easy to pour granular laundry detergent which provides enhanced whitening capabilities.

### BACKGROUND OF THE INVENTION

The use of granular laundry detergents to provide cleaning and whitening benefits to laundry is known. Granular laundry detergents typically comprise anionic surfactants and builders with adjunct ingredients including cleaning and whitening agents. Conventional cleaning and whitening technologies for use with granular laundry detergents include the use of bleaching agents, bleach activators, brighteners and so forth.

Although granular laundry detergents comprising bleaching agents, bleach activators, and brighteners are known to provide consumer desirable performance, consumers typically find granular detergents to be less user friendly than liquid laundry detergents. Further, liquid laundry detergents do not suffer from undesirable caking and residue/dissolution issues known to be problematic with granular laundry detergents. As such, liquid laundry detergents have become more popular.

One problem with liquid laundry detergents is that although the liquid formulation can accommodate high levels of brightener and surfactant, it is difficult to incorporate bleaching technologies into the liquid formulation. Thus, granular laundry detergents provide good cleaning and whitening performance but are considered inconvenient to use. On the other hand, liquid laundry detergents are pourable and easy to use but do not provide the needed whitening and cleaning benefits.

### SUMMARY OF THE INVENTION

One aspect of the present invention provides for a detergent granule comprising at least one composite material, wherein said at least one composite material comprises: a C10-C13 sodium linear alkylaryl sulfonate and/or an alpha-sulfonated fatty acid ester such as methyl ester sulfonate; an alkaline agent, from about 0.05% to about 1.2%, by weight of said granular detergent admix, of an brightener; and from about 10% to about 35%, by weight of said granular detergent admix, of a bleaching system comprising: a source of peroxide; and a bleach activator.

Another aspect of the present invention provides for an article for communicating whitening capabilities comprising: an opaque container which is substantially white; and a granular detergent admix of the present invention.

Yet another aspect of the present invention provides for a method of treating a fabric using the granular detergent admix of the present invention, such as whitening a fabric, and/or cleaning a fabric.

### DETAILED DESCRIPTION OF THE INVENTION

The present invention provides a granular detergent admix comprising: from about 15% to about 50%, alternatively from about 20% to about 35%, alternatively from about 25% to about 30%, by weight of said granular detergent admix, of a surfactant system comprising: an alpha-sulfonated fatty acid ester; a branched surfactant; and an alkyl sulfate surfactant; from about 0.05% to about 1.2%, alternatively at least about 0.1%, alternatively at least about 0.5%, alternatively at least about 0.8% up to about 1%, by weight of said granular detergent admix, of an optical brightener; and from about 10% to about 35%, alternatively from about 15% to about 30%, alternatively from about 20% to about 25%, by weight of said granular detergent admix, of a bleaching system comprising: a source of peroxide; and a bleach activator.

In one embodiment, the granular detergent admix is provided in an article for communicating whiteness, wherein said granular detergent admix is contained within an opaque bottle, wherein said opaque bottle is substantially white.

It has surprisingly been found that detergent granules in accordance with at least one embodiment of the present invention provide important enhanced whitening and cleaning performance. It is further believed that the synergy between the combined elements of the granular detergent admix and the packaging provide enhanced whiteness communication to the consumer. Indeed, this has been surprisingly found that the present invention provides the combined benefits of a compact yet flowable granular detergent admix which provides the whitening benefits desired by consumers looking for an effective whitening product which can be dosed and poured like a liquid composition.

### 1. Granular Detergent Admix

The granular detergent admix of the present invention comprises agglomerated particles and/or extruded particles. In one embodiment, the granular detergent admix is free or essentially free of any blown powder or spray dried powder. As used herein, essentially free means that no added amounts of the specific component are added to the composition aside from any levels which can be present from the raw material, nor is does the process specifically make any amounts of the specified component.

a. Surfactant System

The surfactant system of the present invention comprises a detersive surfactant system comprising an anionic surfactant, a cationic surfactant, a nonionic surfactant, amphoteric surfactant, a zwitterionic surfactant, and mixtures thereof. Those of skill in the art will understand that a detersive surfactant means any surfactant or mixture of surfactants which provide a cleaning, stain removing or otherwise laundering benefit to fabrics during the laundering process. Preferably the surfactant or a portion thereof is in the form of a high active flake, such as a high active LAS or MES flake, having a surfactant content of at least about 50% surfactant, alternatively at least about 75% surfactant, alternatively at least about 90% surfactant. It is believed that by using the high active detergent flake, the composition can be more compact, requiring less surfactant in the form of blown granule. In one embodiment, the surfactant comprises from about 15% to about 50%, by weight of said surfactant system, alternatively from about 20% to about 50%, alternatively from about 35% to about 50%, alternatively from about 45% to about 50% of one or more of the following anionic surfactants.

i. Alpha-Sulfonated Fatty Acid Ester

The surfactant system of the present invention optionally comprises at least one alpha-sulfonated fatty acid ester. Alpha-sulfonated fatty acid esters and methods of manufacturing alpha-sulfonated fatty acid esters are well known to those skilled in the art. See, e.g., U.S. Pat. Nos. 6,376,445; 5,329,030; 5,382,677; 5,384,422; 4,816,188; and 4,671,900. The alpha-sulfonated fatty acid ester can be in the form of a high active flake or can be a composite particle or coated particle comprising other actives or inactives.

Alpha-sulfonated fatty acid esters can be manufactured from a variety of sources, including beef tallow, palm kernel oil, palm stearin oil, coconut oil, soybean oil, canola oil, cohune oil, palm oil, white grease, cottonseed oil, and mixtures thereof.

In one embodiment, the alpha-sulfonated fatty acid ester has the structural formula:

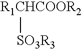

wherein R₁ and R₂ are saturated or unsaturated alkyl groups and R₃ is an alkyl group, a hydrogen, halogen or metal. As defined herein, “alkyl” includes saturated and unsaturated hydrocarbyl chains which is any univalent radical derived from a hydrocarbon. In one embodiment, R₁ is a C₈ to C₂₂ chain, alternatively a C₁₆ to C₁₈ chain. In another embodiment R₂ is a C₁ to C₈ chain, alternatively a methyl group. In another embodiment, R₃ is an alkali metal cation. In one embodiment, the alpha-sulfonated fatty acid ester is a mono-salt of the above formula, wherein R₁ and R₂ are saturated or unsaturated alkyl groups and R₃ is an alkali metal cation. In another embodiment, the alpha-sulfonated fatty acid ester is a di-salt of the above formula, wherein R₁ is a saturated or unsaturated alkyl chain and R₂ and R₃ are alkali metals cations.

In one embodiment, the alpha-sulfonated fatty acid ester is a methyl ester sulfonate surfactant (“MES”). In one embodiment the MES is a mono-salt of sodium methyl ester sulfonate. As will be appreciated by those skilled in the art, the proportions of different types of alpha-sulfonated fatty acid esters can be varied based on the desired processing conditions and end product in light of the properties of the alpha-sulfonated fatty acid esters. Non-limiting examples of suitable alpha-sulfonated fatty acid esters and methods of making them are provided in U.S. Pat. Nos. 6,057,280; 5,616,781; 5,527,489; 5,475,134; 4,438,025; 3,338,838, and U.S. Patent Appl. No. 2008/0009430 A1. The detergent granule can consists essentially of said composite material or can be in the form of a layered granule comprising a seed and at least one layer at least partially coating at least a portion of said seed, wherein said composite material forms either said seed or said at least one layer. The detergent granule of the present invention allows for minimized di-salt formation of the alpha-sulfonated fatty acid ester which provides important dissolution benefits and enhanced cleaning capabilities.

In one embodiment, the alpha-sulfonated fatty acid ester is micronized or ground to a D₅₀ particle size of less than about 100 microns prior to introduction into a mixer to form said detergent granule, alternatively from about 1 micron to about 100 microns, alternatively from about 5 microns to about 50 microns, alternatively from about 10 microns to about 25 microns. It is believed that the alpha-sulfonated fatty acid ester particles which form the composite material retain the same D₅₀ particle size when present in the composite material.

ii. Co-Surfactants

Additional surfactants which can be used in the surfactant system (“co-surfactants”) are any of the surfactants described in U.S. Patent Appl. No. 2008/0009430 A1. Suitable co-surfactants for use herein include: an alkylbenzene sulfonate surfactant; a branched surfactant; an alkyl or alcohol sulfate surfactant; a secondary alkyl or alcohol sulfate surfactant; a nonionic surfactant; and mixtures thereof.

In one embodiment, the surfactant system comprises: (a) from about 9% to about 15%, alternatively from about 10% to about 14%, by weight of said alpha-sulfonated fatty acid ester; (b) from about 49% to about 55%, alternatively from about 50% to about 54%, by weight of said branched surfactant; and (c) from about 18% to about 23%, alternatively from about 20% to about 22%, by weight of said alkyl or alcohol sulfate surfactant.

In another embodiment, the surfactant system comprises: (a) from about 22% to about 49%, alternatively from about 10% to about 30%, by weight said alpha-sulfonated fatty acid ester; (b) from about 0.5% to about 35%, alternatively from about 35% to about 75%, by weight of an alkylbenzene sulfonate surfactant; (c) from about 40% to about 78%, alternatively from about 10% to about 50%, by weight of said branched surfactant; (d) optionally from about 18% to about 23%, alternatively from about 20% to about 22%, by weight of said alkyl or alcohol sulfate surfactant, and (e) optionally from about 0.1% to about 4% by weight of said surfactant system of a nonionic surfactant.

In one embodiment, the co-surfactant comprises an alkylbenzene sulfonate surfactant, such as the hard (ABS, TPBS) linear types, also known as LAS, and made by known process such as: HF or solid HF e.g., DETAL® (UOP) processes; via other Lewis Acid catalysts e.g., AlCl₃; and via acidic silica/alumina or made from chlorinated hydrocarbons, such as C₉-C₂₀ linear alkylbenzene sulfonates, particularly sodium linear alkyl C₁₀-C₁₅ benzene sulfonate. In one embodiment, the alkylbenzene sulfonate surfactant is a water soluble salt or acid typically of the formula R-A-SO₃-M wherein R is a branched or linear C₁₀-C₂₄ alkyl group, alternatively a C₁₀-C₂₀ alkyl, alternatively a C₁₀-C₁₈ alkyl, A is an aryl group, such as benzene or toluene. In one embodiment, A is a benzene unit, and M is H or an alkali metal, ammonium or substituted-ammonium cation. Examples of alkylbenzene sulfonate surfactant are available in U.S. Pat. Nos. 2,220,099; 2,477,383; and 6,602,840.

Suitable anionic surfactants include alkyl dimethylamine oxides having 12 to 25 carbon atoms such as N,N-dimethyl-1-tetradecanamine oxide and N,N-dimethyl-1-octadecananime oxide, sodium lauroyl sarcosinate, diphenyl ether sulfonates such as the alkali metals salts of hexadecyl diphenyl ether disulfonic acid, dodecyl diphenyl ether disulfonic and decyl diphenyl ether disulfonic acid, preferably C10-C18 alkylbenzene sulfonates. Commercially available anionic surfactants which may be used include Ufaryl DL80, DL85 and DL90 of Unger Fabrikker which are mixtures of C10-C13 linear sodium alkylbenzene sulfonate, Udet 950 of De Soto, Nacconol 90G of Stepan Corporation (a C11.7 linear alkylbenzene sulfonate), Calsoft F90 of Pilot Corporation (a C10-C13 sodium linear alkylaryl sulfonate). Witconate 90F of Witco Corporation (a C12 sodium alkylaryl sulfonate containing 1.7% free oil and 3.0% SO4), Nansa HS 80PF of Albright & Wilson Ltd. and Stepan agent S-1509-65 of Stepan Corporation (a C13 calcium dodecylbenzene sulfonate).

In another embodiment, the co-surfactant comprises a branched surfactant. Suitable branched surfactants include, but are not limited to, mid-chain branched alkyl alkoxy alcohols having the formula:

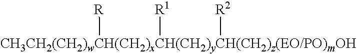

mid-chain branched alkyl sulfates having the formula:

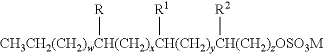

and mid-chain branched alkyl alkoxy sulfates having the formula:

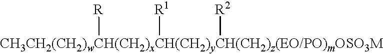

wherein the total number of carbon atoms in the branched primary alkyl moiety of these formulae (including the R, R¹, and R² branching, but not including the carbon atoms which comprise any EO/PO alkoxy moiety) is from 14 to 20, and wherein further for this surfactant mixture the average total number of carbon atoms in the branched primary alkyl moieties having the above formula is from about 14.5 to about 17.5 (alternatively from about 15 to about 17); R, R¹, and R² are each independently selected from hydrogen, C₁-C₃ alkyl, and mixtures thereof, including but not limited to methyl; provided R, R¹, and R² are not all hydrogen and, when z is 1, at least R or R¹ is not hydrogen. M is one or more alkali metal cations, such as sodium and/or potassium. The index w is an integer from 0 to 13; x is an integer from 0 to 13; y is an integer from 0 to 13; z is an integer of at least 1; provided w+x+y+z is from 8 to 14. EO and PO represent ethyleneoxy units and propyleneoxy units having the formula:

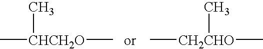

respectively, however, other alkoxy units inter alia 1,3-propyleneoxy, butoxy, and mixtures thereof are suitable as alkoxy units appended to the mid-chain branched alkyl moieties. Suitable branched surfactants for use herein are discussed in U.S. Pat. Nos. 5,780,694; 5,849,960; 6,015,781; 6,020,303; 6,060,443; 6,133,222; and 6,228,829.

Suitable alkyl or alcohol sulfate surfactants, including the secondary alkyl or alcohol sulfate surfactants, are water soluble salts or acids typically of the formula R—O-(A)ₘ-SO₃-M wherein R is an unsubstituted C₁₀-C₂₄ alkyl or hydroxyalkyl group having a C₁₀-C₂₄ alkyl component, alternatively a C₁₂-C₂₀ alkyl or hydroxyalkyl, alternatively C₁₂-C₁₈ alkyl or hydroxyalkyl, A is an ethoxy or propoxy unit, m is greater than zero, typically between about 0.5 and about 6, alternatively between about 0.5 and about 3, and M is H or a cation which can be, for example, an alkali metal cation, ammonium or substituted-ammonium cation. Alkyl ethoxylated sulfates and alkyl propoxylated sulfates are contemplated herein.

In yet another embodiment, the co-surfactant comprises a nonionic surfactant at a level of from about 0.1% to about 4% by weight of said composite material. Non-limiting examples of nonionic surfactants includes 1) C₁₂-C₁₈ alkyl ethoxylates, such as those derived from NEODOL® from Shell; 2) C₆-C₁₂ alkyl phenol alkoxylates wherein the alkoxylate units are a mixture of ethyleneoxy and propyleneoxy units; 3) C₁₂-C₁₈ alcohol and C₆-C₁₂ alkyl phenol condensates with ethylene oxide/propylene oxide block polymers such as PLURONIC® from BASF; 4) C₁₄-C₂₂ mid-chain branched alcohols, as discussed in U.S. Pat. No. 6,150,322; 5) C₁₄-C₂₂ mid-chain branched alkyl alkoxylates, BAEx, wherein x is from 1-30, as discussed in U.S. Pat. Nos. 6,153,577, 6,020,303 and 6,093,856; 6) alkylpolysaccharides as discussed in U.S. Pat. No. 4,565,647; specifically alkylpolyglycosides as discussed in U.S. Pat. Nos. 4,483,780, and 4,483,779; 7) polyhydroxy fatty acid amides (GS-base) as discussed in U.S. Pat. No. 5,332,528, WO Publ. Nos. 92/06162, 93/19146, 93/19038, and 94/09099; 8) ether capped poly(oxyalkylated) alcohol surfactants as discussed in U.S. Pat. No. 6,482,994 and WO Publ. No. 2001/42408; and mixtures thereof.

In another embodiment, the surfactant system further comprises: from 0.1 to about 50%, or from about 1% to about 20%, of the weight of said surfactant system of an alkali metal containing alkylolammonium salts of a higher fatty acid, said higher fatty acid containing from about 8 to about 24 carbon atoms, alternatively from about 12 to about 18 carbon atoms, a “soap”. Soaps can be made by direct saponification of fats and oils or by the neutralization of free fatty acids. Particularly useful are the sodium and potassium salts of the mixtures of fatty acids derived from coconut oil and tallow. See, U.S. Pat. No. 3,936,537.

b. Brightener

Any brighteners (also known as optical brighteners, whitening agents, and fluorescent whitening agents) known in the art can be incorporated into the present invention. In one embodiment, the further comprising at least 0.1%, by weight of said granular detergent admix, of said brightener. In another embodiment, the granular detergent admix comprises from about 0.05% to about 1.2%, by weight of said granular detergent admix, of said brightener.

Commercial optical brighteners which may be useful in the present invention can be classified into subgroups, which include, but are not necessarily limited to, derivatives of stilbene, pyrazoline, coumarin, carboxylic acid, methinecyanines, dibenzothiphene-5,5-dioxide, azoles, 5- and 6-membered-ring heterocycles, and other miscellaneous agents. Suitable brighteners include the PHORWHITE series of brighteners from Verona; Tinopal UNPA, Tinopal CBS and Tinopal 5BM, from Ciba-Geigy; Arctic White CC and Arctic White CWD, from Hilton-Davis, located in Italy; 2-(4-stryl-phenyl)-2H-napthol[1,2-d]triazoles; 4,4′-bis-(1,2,3-triazol-2-yl)-stilbenes; 4,4′-bis(stryl)bisphenyls; aminocoumarins such as 4-methyl-7-diethyl-amino coumarin; 1,2-bis(-venzimidazol-2-yl)ethylene; 1,3-diphenyl-phrazolines; 2,5-bis(benzoxazol-2-yl)thiophene; 2-stryl-napth-[1,2-d]oxazole; and 2-(stilbene-4-yl)-2H-naphtho-[1,2-d]triazole. See, U.S. Pat. Nos. 3,646,015, 4,790,856, 7,049,280 and 7,186,680. In one embodiment, the brightener comprises an anionic brightener such as those disclosed in U.S. Pat. No. 4,446,042.

In one embodiment, the brighter comprises, wherein said optical brightener is selected from the group consisting of derivatives of stilbene, pyrazoline, coumarin, carboxylic acid, methinecyanines, dibenzothiphene-5,5-dioxide, azoles, 5- and 6-membered-ring heterocycles, and mixtures thereof. In another embodiment, the brightener comprises disodium 4,4′-bis{[4-anilino-6-morpholino-s-triazin-2-yl]-amino}-2,2′-stilbenedisulfonate.

In one embodiment, the level of brightener, when dosed into a conventional automatic home laundering machine having a volume of from about 64 L to about 75 L creates a brightener concentration in the wash bath of from about 1 ppm to about 10 ppm, alternatively from about 3 ppm to about 7 ppm, alternatively from about 5 pm to about 6 ppm. Those of skill in the art will understand that the ppm concentration for a given component of the granular detergent admix of the present invention can be calculated by dividing the milligrams of the given component (i.e., brightener or bleaching system) by the liters of water in aqueous bath. For example, where a 50 gram unit dose of the granular detergent admix comprising about a 1% of said brightener, is dosed into a 64 L to 75 L wash bath, the resultant brightener concentration is from about 6.7 ppm to about 7.8 ppm.

It is believed that the high levels of brightener, above 0.1%, alternatively above 0.5% by weight, alternatively above 0.75%, provide the important benefit of making the clothing more vibrant in appearance and color. In addition to making the laundered fabrics clean and white, the granular detergent comprises an amount of brightener to provide enhanced color appearance of the treated fabrics.

c. Bleaching System

In one embodiment, the granular detergent admix comprises a source of peroxygen, a bleach activator, and mixtures thereof. Sources of peroxygen, also known as bleaching agents, are capable of yielding hydrogen peroxide in an aqueous solution and are known in the art. Non-limiting examples of sources of peroxygen suitable for use herein include sodium perborate monohydrate, sodium perborate tetrahydrate, sodium carbonate peroxyhydrate, sodium pyrophosphate peroxyhydrate, urea peroxyhydrate, sodium peroxide, and mixtures thereof. In one embodiment, the source of peroxygen comprises a sodium carbonate peroxyhydrate.

Non-limiting examples of bleach activators include sodium or potassium salts of nonanoyloxybenzene sulfonate (NOBS), 3,5,5-tri-methyl hexanoyloxybenzene sulfonate (iso-NOBS); benzoyloxybenzene sulfonate (BOBS); lauroyloxybenzene sulfonate (LOBS), decanoly oxy benzoic acid or salt thereof, dodecanoyloxy-benzene sulfonate, and decanoyloxy-benzenesulfonate (DOBS); tetraacetyl ethylene diamine (TAED), nonanoylamido peroxo-adipic acid (NAPAA); and mixtures thereof. Additional bleaching agents and activators are disclosed in U.S. Pat. Nos. 5,891,838 and 6,444,634; and WO 99/20726 at page 78 et seq.

Without intending to be bound by theory, it is now believed that the relative levels of the source of peroxide to the bleach activate determine the relative amount of peracid formation which provides enhanced stain removal, or increased peroxide formation which provides enhanced whitening and bleaching performance. It is believed that a weight ratio of said source of peroxide to said bleach activator of up to 2.5:1 provides enhanced whitening and bleaching benefits. In one embodiment, the bleaching system comprises a weight ratio of said source of peroxide to said bleach activator of from about 1:1: to about 10:1, alternatively from about 2:1 to about 5:1, alternatively from about 2.5:1 to about 4:1. Without intending to be bound by theory, it is believed that by providing such high levels of bleach activator provide important enhanced whitening capabilities. It has importantly been found that the combined elements of the present surfactant system, with the brightener and specific levels and ratios of the bleaching system, the present invention provides for enhanced whitening and cleaning performance.

It has surprisingly been found that the level of carbonate is also an important factor in determining the treatment performance of the granular detergent admix. Importantly, it has been found that the relative amount of carbonate in the formulation impacts the speed in which the bleaching system forms peracid when contacted with wash water. In one embodiment, the level of carbonate is kept below about 200 ppm in the wash.

In one embodiment, where the granular detergent admix comprises low levels of total surfactant system such as below about 30% by weight, or below 25% by weight, the specified weight ratio of bleaching agent to bleach activator provides unexpected performance benefits without unduly affecting the flowability of the composition. It is believed that despite the decreased level of surfactant system, the specific weight ratio of the source of peroxygen and the bleach activator provide suitable cleaning and whitening performance.

In one embodiment, the bleaching system is free or essentially free of a chlorine bleach, a bromine bleach and/or a manganese bleach. As used herein, essentially free means that no added amounts of the specific component are added to the composition aside from any levels which can be present from the raw material.

d. Organic Catalyst

In one embodiment, the granular detergent admix further comprises an organic catalyst such as described in U.S. Pat. No. 7,557,076. In one embodiment, the organic catalyst has Formula 1 or Formula 2 below or mixtures thereof.

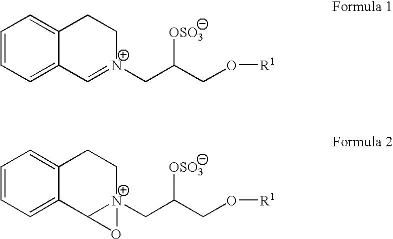

wherein R₁ is a branched alkyl group containing from 9 to 24 carbons or linear alkyl group containing from 11 to 24 carbons; a branched alkyl group containing from 9 to 18 carbons or linear alkyl group containing from 11 to 18 carbons; is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl; or is selected from the group consisting of 2-butyloctyl, 2-pentylnonyl, 2-hexyldecyl, iso-tridecyl and iso-pentadecyl.

In one embodiment, the organic catalyst is provided in the granular detergent admix in a non-surfactant active containing delivery particle having a coating such as described in the specification of U.S. Patent Publ. no. 2005/0181969 and in Example 2. In one embodiment, the coated particle comprises a core or seed and a coating comprising the organic catalyst or a combination of organic catalyst, and one or more adjunct ingredients. Additional examples of suitable particles which can be used to deliver the organic catalyst include U.S. Serial No. 2007/196502 and EP 1881059. This coated particle may be particularly preferable if using an alpha sulfonated fatty acid ester such as MES as a surfactant.

e. Adjunct Ingredients

i. Alkaline Agent

In one embodiment of the present invention, the granular detergent admix comprises from about 1% to about 85%, by weight of a builder, alternatively from about 20% to about 70%, alternatively from about 30% to about 50%. In one embodiment the builder comprises: one or more alkali metal containing builders such as: a non-water soluble builder; a water soluble builder; and a mixture thereof. Suitable non-water soluble alkali metal containing builders include: alkali metal containing aluminosilicates, known in the art as zeolites; alkali metal containing crystalline layered silicates; and mixtures thereof. Suitable water soluble alkali metal containing builders comprise inorganic builders and organic builders as listed below, and mixtures thereof.

In one embodiment, the granular detergent admix comprises one or more inorganic non-water soluble alkali metal containing silicates, such as sodium aluminosilicates, crystalline layered silicates, and mixtures thereof. Examples of sodium aluminosilicate are Zeolites, such as Zeolite A, Zeolite P(B), Zeolite MAP, and Zeolite X. See, e.g., U.S. Pat. Nos. 6,140,401; 5,104,568; 4,605,509; 4,274,975; and 3,985,669. Zeolite A, for example, has the formula: Na₁₂[(AlO₂)₁₂(SiO₂)₁₂]xH₂O, where x is from about 20 to 30, alternatively about 27. In one embodiment the sodium aluminosilicate comprises a SiO₂:Na₂O ratio in the range about 1.6:1 to about 3.2:1. In another embodiment, the sodium aluminosilicate has a D₅₀ particle size of from about 0.1 micron to about 10 micron. Examples of crystalline layered silicates are described in U.S. Pat. No. 4,664,839 Rieck, issued May 12, 1987. NaSKS-6® is the trademark for a crystalline layered silicate marketed by Hoechst (commonly abbreviated as “SKS-6”). Unlike zeolite builders, the NaSKS-6 silicate builder does not contain aluminum. Suitable builders including the alkali metal silicates are described in U.S. Pat. No. 6,479,451.

Non-limiting examples of suitable inorganic water-soluble builders including: carbonates, borates, phosphates, bicarbonates, and mixtures thereof. Examples include sodium and potassium tetraborates, bicarbonates, carbonates, orthophosphates, pyrophosphates, tripolyphosphates and metaphosphates.

Non-limiting examples of suitable organic water-soluble alkali metal containing builders include: 1) aminocarboxylates and aminopolyacetates, i.e., nitrilotriacetates, glycinates, ethylenediaminetetraacetates, N-(2-hydroxyethyl)nitrilo diacetates and diethylenetriamine pentaacetates; 2) salts of phytic acid, for example, sodium and potassium phytates; 3) polyphosphonates, including sodium, potassium, and lithium salts of ethane-1-hydroxy-1,1-diphosphonic acid; sodium, potassium, and lithium salts of ethylene diphosphonic acid; and the like; 4) polycarboxylates, i.e., salts of acrylic acid, succinic acid, malonic acid, maleic acid, citric acid, 2,2′-oxodisuccinic acid, carboxymethyloxysuccinic acid, 2-oxa-1,1,3-pro-panetricarboxylic acid, 1,1,2,2-ethanetetracarboxylic acid, mellitic acid, pyromellitic acid, and polyacrylate; 5) poly-acetals as disclosed in U.S. Pat. Nos. 4,144,266 and 4,246,495; 6) tartrate monosuccinates and tartrate disuccinates, and mixtures thereof, disclosed in U.S. Pat. No. 4,663,071; 7) sulfamic acid and/or water-soluble salts thereof; and 8) mixtures thereof.

In one embodiment, the granular detergent admix comprises a polyacrylate builder, such as a sodium polyacrylate builder. In one embodiment, the polyacrylate builder comprises a granular form or a powder form.

In one embodiment, the granular detergent admix comprises a builder other than the aluminosilicate builders and/or phosphate builders. Suitable builders for use in the absence of aluminosilicate and/or phosphate builders include the organic water-soluble alkali metal containing builders as disclosed herein. In one embodiment, the granular detergent admix comprise low levels, i.e., less than about 10%, or about 5%, or about 1% of aluminosilicate and/or phosphate builders, while comprising relatively high levels, i.e., from about 15% up to about 85%, or from about 50% up to about 80%, or about 60% up to about 75%, of organic water soluble containing builders. In one embodiment, the weight ratio of the organic water soluble builders to non-water soluble builder is at least about 5:1, or at least about 10:1, or at least about 15:1, or at least about 20:1 or even at least about 25:1.

Those of skill in the art will understand that although certain non-limiting examples of alkali metal containing materials are disclosed as suitable alkaline agents, any conventional alkali containing ingredient typically used in a laundry detergent composition is suitable for use herein.

ii. Adjunct Ingredients

In another embodiment, the granular detergent admix further comprises from about 0.1% to about 15%, alternatively from about 1% to about 10%, alternatively less than about 5%, alternatively less than about 2%, by weight of any one or more of the adjunct ingredient, disclosed herein and which are conventionally included in detergent compositions. Non-limiting examples of adjunct ingredients are: enzymes such as proteases and amylases, perfumes, starch encapsulated perfumes, cyclodextrin encapsulated perfumes, or other perfume microcapsules as known in the art, co-solvents, cleaning agents, antibacterial agents, antistatic agents, dye fixatives, dye abrasion inhibitors, anti-crocking agents, wrinkle reduction agents, wrinkle resistance agents, soil release polymers, sunscreen agents, anti-fade agents, builders, sudsing agents, composition malodor control agents, dyes, colorants, speckles, pH buffers, waterproofing agents, soil repellency agents, chelants such as diethylene triamine pentaacetic acid (DTPA); and mixtures thereof. In another embodiment, the granular detergent admix is free or essentially free of any of the aforementioned adjunct ingredients. Essentially free means that no added amount of said ingredient is added during the processing of the composition.

In one embodiment, the detergent granule admix further comprises less than about 10% by weight of moisture, alternatively less than about 5%, alternatively less than about 1%. In another embodiment, the composite material is free or essentially free of moisture. As defined herein, essentially free means that no additional amount of the component is added to the composition. Those of skill in the art will understand that moisture includes both free water which can be added as an adjunct ingredient or as bound moisture provided by either the alkaline agent or the binding agent. For example, commercially available alkali metal containing aluminosilicates commonly have from 7% to about 25% of bound water by weight.

Non-limiting examples of adjunct ingredients suitable for use in laundry detergents are described in U.S. Pat. Nos. 6,488,943; 6,514,932; 6,548,470; 6,482,793; 5,545,350; 5,756,444; 6,083,899; 6,156,722; 6,573,234; 6,525,012; 6,551,986; 6,566,323; 6,090,767; and 6,420,326.

### 2. Granular Detergent Admix Particle Size and Flowability

In one embodiment, the detergent granule comprises a median particle dimension of from about 250 microns to about 4000 microns, alternatively from about 300 microns to about 1,200 microns, alternatively from about 400 microns to about 1000 microns, alternatively from about 500 microns to about 850 microns, alternatively from about 600 microns to about 750 microns. In anther embodiment, the granular detergent admix comprises a volume average particle size of from 400 microns to 800 micron, alternatively from about 600 microns to about 750 microns, and preferably wherein no more than 20% of the particles have a particle size of less than about 125 microns, and preferably wherein no more than 20% of the particles a particle size of about 1180 microns or greater.

In one embodiment the detergent granule comprises a bulk density of from about 350 grams/liter to about 2000 grams/liter, alternatively from about 600 grams/liter to about 1200 grams/liter, alternatively from about 800 grams/liter to about 1000 grams/liter. Those of skill in the art will understand that embodiments of the present invention which do not include spray dried blown granule can be produced with higher bulk densities, i.e., bulk densities above 600 grams/liter.

Suitable test methods for determining the median particle size of the granular detergent admix and the bulk density are performed as described in U.S. Patent Appl. No. 2007/0196502 A1. The weight average particle size can be determined using a Sympatec laser diffraction instrument, which calculates the volumetric mean diameter of the powder.

The granular detergent admix has good flowability properties. In one embodiment, the granular detergent admix comprises a Silo Peschel flowability grade of from about 3 to about 8, alternatively from about 4 to about 7, alternatively from about 5 to about 6. In another embodiment, the granular detergent admix comprises a Bag Peschel flowability grade of from about 5 to about 11, alternatively from about 7 to about 9. The Silo and Bag Peschel flowability grades are determined in accordance with the test methods defined below.

It is believed that the flowability benefits achieved with the present invention are accomplished without unduly limiting the cleaning and whitening performance when used in the washing process. This is believed to be the result of removing the blown powder and/or spray dried powder from the formulation. In order to remove the blown powder, yet retain a high enough level of surfactant system, the present invention comprises a surfactant system comprising an alpha-sulfonated fatty acid ester. It has been found that the alpha-sulfonated fatty acid ester, allows for a high amount of surfactant to be provided without the need to use a blown powder comprising a sprayed on linear alkyl benzene sulfonate surfactant (hereinafter “LAS”). Conventional commercially marketed granular laundry detergents include blown powder comprising a sprayed on LAS or non-ionic surfactant. It has been found that surprisingly, despite the absence of the blown powder, the present invention provides sufficient detersive surfactant activity to provide the cleaning and whitening performance required.

### Method for Determining the Silo Peschel Flowability Grade:

A 50 g sample of the granular laundry admix is poured into a shear cell and leveled. The shear cell is then covered and the auxiliary composition undergoes a pre-consolidation step prior to the test by placing a 7,500 g weight onto the powder. The shear cell is then placed onto a Peschel RO 200 Automatic Rotational Shear Tester, where it undergoes the consolidation step under a load of 250 g/cm² to orientate the particles in the sample to a constant resistance to horizontal movement (shear). Once the machine senses this constant resistance, a load of 250 g/cm² is applied and the force require to restart horizontal motion is measured. This last step is repeated with 4 further different loads of 200 g/cm², 150 g/cm², 100 g/cm² and 50 g/cm². The relative flowability is calculated from the absolute flowability/bulk specific gravity of the product.

The flowability values are derived from a plot of the shear pressure vs vertical load which is used to determine a yield locus from which Mohr's circles are drawn. From these, the relative flowability is calculated. The Silo Peschel flowability grade is the relative flowability.

### Method for Determining the Bag Peschel Flowability Grade:

A 50 g sample of the granular laundry admix is poured into a shear cell and leveled. The shear cell is then covered and the auxiliary composition undergoes a pre-consolidation step prior to the test by placing a 1,500 g weight onto the powder. The shear cell is then placed onto a Peschel RO 200 Automatic Rotational Shear Tester, where it undergoes the consolidation step under a load of 50 g/cm² to orientate the particles in the sample to a constant resistance to horizontal movement (shear). Once the machine senses this constant resistance, a load of 50 g/cm² is applied and the force require to restart horizontal motion is measured. This last step is repeated with 4 further different loads of 40 g/cm², 30 g/cm², 20 g/cm² and 10 g/cm². The relative flowability is calculated from the absolute flowability/bulk specific gravity of the product.

The flowability values are derived from a plot of the shear pressure vs vertical load which is used to determine a yield locus from which Mohr's circles are drawn. From these, the relative flowability is calculated.

### 3. Article for Communicating Whiteness

Consumers have surprisingly been found to prefer a granular detergent admix which is compact yet is flowable and can pour like a liquid. It has been found that the specific combination of surfactant system, brightener, and bleaching system provide the enhanced cleaning and whitening performance while the granular detergent being flowable and compact (being free or essentially free of blown powder), provides for the benefit of being pourable like a liquid. Unlike liquid laundry detergents, which typically lack sufficient whitening performance due to the limited ability to provide liquid formulations comprising bleaching technology, the present invention has surprisingly arrived at a way to provide enhanced cleaning and whitening performance while in an article which provides an enhanced communication of whiteness and whitening benefits to the consumer.

In addition to the cleaning and whitening performance, the present invention also provides an enhanced way to communicate whitening to the consumer. Without intending to be bound by theory, it is believed that when the present granular detergent admix is provided in a white, substantially white or off white color and is contained within a white, substantially white or off white color bottle, consumers experience a more holistic whitening experience and understand that the present product is particularly suitable for laundering white fabrics, although it is also suitable for laundering colored fabrics as well.

In one embodiment of the present invention, the granular detergent admix is white or substantially white to off white. In one embodiment, the granular detergent admix is free or substantially free of non-white speckled particles and/or dye. In another embodiment, as determined by the Hunter Method for powder samples as defined herein, the granular detergent admix has an “L” value of from about 80 to about 100; alternatively from about 85 to about 95; and alternatively from about 89.9 to about 92.3. In one embodiment, the liquid compositions of the present invention have an “a” value of from about −5 to about zero; alternatively from about −3 to about −0.5; and alternatively from about −2.1 to about −0.6. In one embodiment, the liquid compositions of the present invention have a “b” value of from about zero to about 12; alternatively from about 2 to about 10; and alternatively from about 4.5 to 7.8.

### Hunter Method:

Color measurements referenced herein are determined by the use of Hunter Method “Lab” numbers for color. The Hunter Method entitled “Reflection Color of Detergent” is used to determine the reflected color of liquids, granules, or other solid objects using a commercially available Colorimeter with HunterLab Universal Software Package, UV control, Port Down Stand, and Sample Clamp. The sample composition is placed in a sample holder and the top surface leveled. The sample is then presented to the instrument and the reading taken. The sample color is reported in terms of three values:

L: Lightness—Black to White

a: Red to Green

b: Yellow to Blue

These three values characterize the color of the sample. The apparatus and model used for this testing is the HungerLab LabScan XE (LSXE) with 2.5″ glass HunterLab sample cups number 04-7209-00. The Hunter Color Difference Meter is calibrated according to manufacturer's directions with the Scale set to “XYZ”, Illuminant set to “D65” and Observer set to “10°”. When the apparatus is ready for use, the Scale is set to “Hunter L,a,b”, Illuminant set to “C” and Observer set to “2°”. The sample dish is filled to overflowing, then an even surface is leveled. The Hunter L,a,b values are then read and recorded.

In addition the bottle containing the granular detergent admix and used to dose the granular detergent admix is also white, substantially white, or off white. In one embodiment, the bottle comprises a white, non-white, or clear label covering from about 10% to about 30% of the total surface area of the bottle, alternatively from about 20% to about 25%. In one embodiment, the portion of the bottle not covered by the label, when tested with the Hunter Method for bottles as defined here, has an “L” value of from about 75 to about 100; alternatively from about 85 to about 90; and alternatively from about 87.2 to about 89.3. In one embodiment, the liquid compositions of the present invention have an “a” value of from about −5 to about zero; alternatively from about −3 to about −0.5; and alternatively from about −1.4 to about −0.9. In one embodiment, the liquid compositions of the present invention have a “b” value of from about zero to about 7; alternatively from about 2 to about 5; and alternatively from about 2.5 to 3.5.

To measure the L,a,b values of the bottle, cut a 1 inch by 1 inch flat portion of the bottle which is not covered by any labels. Place the bottle cut out into the HunterLab Sample cup and set the Illuminant to “D65” with all other settings being the same as disclosed above.

It has been surprisingly found that the apparatus according to at least one embodiment of the present invention provides for enhanced communication of whitening benefits. A method of whitening a fabric comprising: providing a load of soiled fabrics, including whites and/or colored fabrics, into the basin of a washing machine; dosing of white detergent composition from a bottle containing the present granular detergent admix to form a wash bath solution; and washing said soiled fabrics in said wash bath solution. In one embodiment, the step of dosing is performed by pouring a volume of said granular detergent admix into a dosing cap and dosing into the basin of the top loading automatic washing machine or the dispensing container of the front loading automatic washing machine.

### 4. Method of Use

In one embodiment of the present invention, the granular detergent admix is used for treating a fabric in any conventional automatic laundering process known in the art. For example, it is suitable for using the granular detergent admix in a top load or front load washing machine. The method of treating the fabric can be for cleaning such as removing stains or soils and/or for whitening the fabrics. In one embodiment the method of using the granular detergent admix comprises the steps of: dosing the granular detergent admix into a measuring cup, such as by pouring the granular detergent admix directly into the measuring cup as opposed to scooping, dosing the contents of the measuring cup into a wash bath to form a wash bath solution; and contacting said wash bath solution with fabrics. Additional steps of rinsing and drying the fabrics are also in accordance with the present invention.

### 5. Examples

Granular detergent admix formulations prepared in accordance with the below formulas are in accordance with the present invention:

### Example 1

| Component | Wt. % |
|---|---|
| NOBS | 3.31 |
| Brightener | 0.5606 |
| Percarbonate | 10.6 |
| Sodium C14-C15 alkyl sulfate (C45AS) | 6.2819 |
| C11-13 alkyl benzene sulfonic acid (HSAS) | 9.4229 |
| MES or LAS Flake | 3.06 |
| Na2CO3 | 14.9275 |
| Zeolite A | 31.3233 |
| Starch encapsulated perfume | 0.4500 |
| NaHCO3 | 5.1500 |
| Water and Misc | Balance |

### Example 2

| Component | Wt. % |
|---|---|
| NOBS | 3.31 |
| Brightener | 0.5606 |
| Protease Enzyme | 0.15 |
| Percarbonate | 10.6 |
| Sodium C14-C15 alkyl sulfate (C45AS) | 6.2631 |
| C11-13 alkyl benzene sulfonic acid (HSAS) | 9.3947 |
| MES or LAS Flake | 3.32 |
| Na2CO3 | 15.1896 |
| Zeolite A | 31.4292 |
| Starch encapsulated perfume | 0.4500 |
| spray on perfume | 0.6000 |
| NaHCO3 | 4.9700 |
| Water and Misc | Balance |

### Example 3

| Component | Wt. % |
|---|---|
| Brightener | 0.5820 |
| C45AS | 4.7638 |
| Citric Acid | 0.0127 |
| Protease enzyme | 0.1500 |
| HSAS | 11.1155 |
| Sodium Linear C11-13 alkyl benzene sulfonate (LAS) | 0.1458 |
| MES or LAS Flake | 5.5250 |
| NOBS | 3.8486 |
| Na2CO3 | 15.0651 |
| Na2O | 0.1216 |
| Na2SO4 | 0.1419 |
| NaHCO3 | 4.7378 |
| Polyethylene glycol | 1.4711 |
| Palmitic Acid | 0.2771 |
| Percarbonate | 9.6000 |
| Perfume (Encaps) | 0.0486 |
| Perfume (Spray-on) | 0.6000 |
| Silica | 0.0045 |
| Silicone | 0.0249 |
| Silicone Glycol | 0.0043 |
| Starch | 0.1143 |
| Zeolite A | 29.4424 |
| Misc | 1.6176 |
| Water (Bound) | 1.1201 |
| Water (Free) | 6.9030 |
| Total Parts | 100.0000 |

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Except as otherwise noted, the articles “a,” “an,” and “the” mean “one or more.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A granular detergent admix comprising:
a. from about 15% to about 50%, by weight of said granular detergent admix, of a surfactant system comprising at least one of:
i. a C10-C13 sodium linear alkylaryl sulfonate,
ii. a methyl ester sulfonate surfactant; and
iii. a mixture thereof;
b. from about 0.05% to about 1.2%, by weight of said granular detergent admix, of an brightener; and
c. from about 10% to about 35%, by weight of said granular detergent admix, of a bleaching system comprising:
i. a source of peroxide; and
ii. a bleach activator.

2. The granular detergent admix of claim 1, wherein said bleaching system comprises a weight ratio of said source of peroxide to said bleach activator of from about 1:1: to about 10:1.

3. The granular detergent admix of claim 2, wherein said bleach activator comprises nonanoyloxybenzene sulfonate, 3,5,5-tri-methyl hexanoyloxybenzene sulfonate; benzoyloxybenzene sulfonate; lauroyloxybenzene sulfonate, decanoly oxy benzoic acid or salt thereof, dodecanoyloxy-benzene sulfonate, and decanoyloxy-benzenesulfonate; tetraacetyl ethylene diamine, nonanoylamido peroxo-adipic acid; and mixtures thereof.

4. The granular detergent admix of claim 2, wherein said source of peroxide is selected from the group consisting of: sodium perborate monohydrate, sodium perborate tetrahydrate, sodium carbonate peroxyhydrate, sodium pyrophosphate peroxyhydrate, urea peroxyhydrate, sodium peroxide, and mixtures thereof.

5. The granular detergent admix of claim 1, further comprising at least 0.1%, by weight of said granular detergent admix, of said brightener.

6. The granular detergent admix of claim 5, wherein said optical brightener is selected from the group consisting of derivatives of stilbene, pyrazoline, coumarin, carboxylic acid, methinecyanines, dibenzothiphene-5,5-dioxide, azoles, 5- and 6-membered-ring heterocycles, and mixtures thereof.

7. The article of claim 1, wherein the white detergent composition comprises a bulk density from about 600 g/l to about 1000 g/l.

8. The granular detergent admix of claim 7, wherein the white detergent composition is substantially free of a blown powder.

9. The granular detergent admix of claim 8, further comprising a high active flake, wherein the high active flake comprises at least about 50% by weight of said high active flake of said surfactant system.

10. The granular detergent admix of claim 1, further comprising a non-surfactant containing particle comprising: an organic catalyst selected from the group consisting of organic catalysts having the following formulae: 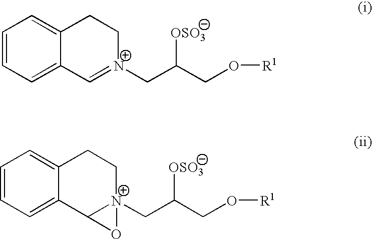
(iii) and mixtures thereof;
wherein each R¹ is independently a branched alkyl group containing from 9 to 24 carbons or linear alkyl group containing from 11 to 24 carbons.

11. The granular detergent admix of claim 1, wherein said granular detergent admix comprises an “L” value of from about 80 to about 100; an “a” value of from about −5 to about zero; and a “b” value of from about zero to about 12 as determined by the Hunter Method as defined herein.

12. The granular detergent admix of claim 11, free or essentially free of a non-white speckled particles and/or a dye.

13. The granular detergent admix of claim 1, wherein said surfactant system comprises:
a. from about 9% to about 15%, by weight of said surfactant system of said alpha-sulfonated fatty acid alkyl ester;
b. from about 49% to about 55% by weight of said surfactant system of said branched surfactant; and
c. from about 18% to about 23%, by weight of said surfactant system of said alkyl or alcohol sulfate surfactant.

14. The granular detergent admix of claim 1, wherein the surfactant system comprises:
a. from about 22% to about 49%, by weight of said surfactant system of said alpha-sulfonated fatty acid alkyl ester;
b. from about 40% to about 78% by weight of said surfactant system of said branched surfactant;
c. from about 18% to about 23% by weight of said surfactant system of said alkyl or alcohol sulfate surfactant;
d. from about 0.6% to about 35%, by weight of said surfactant system of an alkylbenzene sulphonate surfactant; and
a. optionally from about 0.1% to about 4% by weight of said surfactant system of a nonionic surfactant.

15. An article comprising: a granular detergent admix of claim 1, contained within a an opaque container which is substantially white.

16. The article of claim 15, wherein said opaque container further comprises at least one indicia which includes the word WHITE.

17. The article of claim 15, wherein said opaque container comprises an “L” value of from about 75 to about 100; an “a” value of from about −5 to about zero; and a “b” value of from about zero to about 7, as determined with the Hunter Method as defined here.

18. The article of claim 17, wherein said granular detergent admix is substantially white and comprises an “L” value of from about 80 to about 100; an “a” value of from about −5 to about zero; and a “b” value of from about zero to about 12 as determined by the Hunter Method for powder samples as defined herein; and said

19. The article of claim 18, wherein said surfactant system comprises from about 9% to about 15%, by weight of said surfactant system of said alpha-sulfonated fatty acid alkyl ester; from about 49% to about 55% by weight of said surfactant system of said branched surfactant; and from about 18% to about 23%, by weight of said surfactant system of said alkyl or alcohol sulfate surfactant; wherein said bleaching system comprises a weight ratio of said source of peroxide to said bleach activator of from about 1:1: to about 10:1; and wherein said optical brightener is at a level comprising at least 0.1%, by weight of said granular detergent admix.

20. A method of whitening a fabric comprising: providing a load of fabrics into the basin of a washing machine; dosing a granular detergent admix of claim 1 to form a wash bath solution; and washing said fabrics in said wash bath solution.
